(19) United States
(12) Patent Application Publication
(10) Pub. No.: US 2007/0300302 A1
(43) Pub. Date: Dec. 27, 2007

(54) Suppresssion Of False Alarms Among Alarms Produced In A Monitored Information System

(75) Inventors: Benjamin Morin, Rennes (FR); Jouni Viinikka, Caen (FR)

Correspondence Address: COHEN, PONTANI, LIEBERMAN & PAVANE, 551 FIFTH AVENUE, SUITE 1210, NEW YORK, NY, 10176, US

(73) Assignee: France Telecom, Paris (FR)

(21) Appl. No.: 11/791,729

(22) PCT Filed: Nov. 24, 2005
(86) PCT No.: PCT/FR05/50983

§ 371 Date: Aug. 27, 2007

(30) Foreign Application Priority Data
Nov. 26, 2004 (FR) 0412559

(51) Int. Cl. G06F 11/30

(52) U.S. Cl. 726/23

(57) ABSTRACT

A method of suppressing false alarms produced in a monitored information system (1). The alarms are classified automatically by means of a false alarm suppression module (17) into two categories consisting of false alarms and true alarms depending on particular criteria based on progressive training of said module (17) based on the expertise of a human operator (23) responsible for initial manual classification of alarms.

### BACKGROUND OF THE INVENTION

The invention relates to a system and a method for suppressing false alarms produced in a monitored information system.

Making information systems secure involves deploying intrusion detection systems. These intrusion detection systems are situated on the upstream side of intrusion prevention systems. They detect activities contravening the security policy of an information system.

Intrusion detection systems include intrusion detection sensors that send alarms to alarm management systems.

Intrusion detection sensors are active components of the intrusion detection system that analyze one or more sources of data in search of events that are characteristic of an intrusive activity and they send alarms to the alarm management system. An alarm management system centralizes the alarms coming from the sensors and where appropriate carries out an analysis of all of those alarms.

Alarm management systems consist of a plurality of alarm processing modules responsible for processing alarms downstream of their production by the intrusion detection sensors. The alarm processing modules themselves produce alarms of higher level that reflect their processing of the alarms.

Once processed by the modules of the alarm management system, alarms are presented to a security operator of the information system on an alarm presentation console.

Alarm processing modules include false alarm suppression modules for identifying false positives, which are alarms generated by the intrusion detection sensors even though there has been no intrusive activity. Alarms produced when an intrusive activity has actually taken place are called true positives.

Intrusion detection sensors generate a very large number of alarms as a function of the configuration and the environment, possibly as many as several thousand alarms each day.

This surplus of alarms is for the most part linked to false alarms. As a general rule, 90% to 99% of the thousands of alarms generated every day in an information system are false alarms.

However, analyzing the causes of these false alarms shows that it is very often a question of entities (for example servers) of the monitored network behaving erratically but in a manner that is not pertinent to the security of the information system. It may also be a question of entities behaving normally performing activity that resembles an intrusive activity to the point that the intrusion detection sensors generate alarms erroneously.

Since such normal behavior constitutes the majority of the activity of an entity, the corresponding false alarms are generated repetitively and contribute greatly to the overall surplus of alarms.

Poor implementation of the security policy of the information system in the configuration of the intrusion detection sensor may also generate false alarms. In any event, the nature (true or false positive) of an alarm depends greatly on the intrinsic properties of the monitored information system.

In current alarm management systems, the qualification of an alarm as a true or false positive is left to the judgment of the security operator responsible for analyzing the alarms, because the operator knows the properties of the information system. Since the number of alarms generated is high, the time that the operator can devote to each alarm is short.

There exist probabilistic techniques for processing alarms from intrusion detection sensors in order to detect false alarms. Those techniques rely on prior knowledge of the properties of the attacks to which the alarms refer and the properties of the monitored information system.

### OBJECT AND SUMMARY OF THE INVENTION

Objects of the invention are to solve these problems and to provide a simple method of suppressing false alarms that requires no prior knowledge and enables real, easy and fast diagnosis of alarms.

These objects are achieved by a method of suppressing false alarms produced in a monitored information system, wherein alarms are classified automatically by a false alarm suppression module into two categories consisting of false and true alarms depending on particular criteria based on progressive training of said module based on the expertise of a human operator responsible for initial manual classification of alarms, said progressive training including the following stages:

an initial training stage in which said false alarm suppression module proceeds to store diagnoses by the human operator concerning a particular number of initial alarms and comprising, for a given initial alarm, extracting a set of words constituting said given initial alarm and associating each word of said set of words with a count designating the cumulative number of occurrences of said word in one of the two categories; and

a validation stage in which said false alarm suppression module classifies new alarms as a function of the stored diagnoses under the supervision of the human operator, who confirms or corrects its classification of new alarms.

Thus the method of the invention facilitates the work of the security operator by enabling the false alarm suppression module progressively to learn the operator's work, in order, at the end of this training period, and with no prior knowledge, to offer the operator automatic diagnoses as to the nature of the alarms. The progressive and supervised training of the false alarm suppression module takes optimum account of modifications that may be made by the security operator at the same time as providing a simple way to measure the frequency of occurrence of words in the false and true alarm categories.

These particular criteria include comparing the probabilities of the alarms belonging to each of the two categories.

Thus a probabilistic comparison technique guarantees effective and measurable training.

In the validation stage, the false alarm suppression module advantageously uses the confirmation or correction of its classifications of new alarms by the human operator to minimize a correction rate, thereby enabling it to increase the reliability of any subsequent classification of new alarms.

Thus the correction rate quantifies the reliability of the classification of alarms and consequently enhances subsequent classification of new alarms.

According to another feature of the invention, the method includes an operational stage in which new alarms are classified autonomously if the correction rate of the classification of new alarms in the validation stage falls below a particular threshold.

Thus the correction rate provides reliable filtering for changing to a stage of autonomous classification of new alarms.

According to a further feature of the invention, in the operational stage, false alarms are suppressed or stored in storage means and only true alarms are sent to an alarm presentation console.

This considerably reduces the volume of alarms that need to be shown to the human security operator.

The classification of alarms during the validation stage and the operational stage includes the following steps for a given new alarm:

extracting the set of words constituting said given new alarm;

comparing the probabilities of the given new alarm belonging to one and the other of said categories;

classifying the given new alarm in one of the two categories depending on the result of the comparison in the preceding step;

incrementing the counts as a function of the category of the given new alarm; and

sending the given new alarm as classified in this way to the alarm presentation console.

Thus by using the set of words constituting the alarms and their associated counts in the above steps, alarms may be classified with continuously increasing reliability.

Comparing the probabilities of the given new alarm belonging to one or the other of said categories includes the following steps:

computing for each word of the set of words of said new alarm the probability that each word is present in alarms belonging to one or the other of the categories by determining the ratio between the count designating the cumulative number of occurrences of each word in alarms of one or the other of the categories and the total number of occurrences of words in one or the other of the categories, respectively;

computing the probability of each category by determining the ratio between the total number of occurrences of words in alarms of each category and the total number of words;

computing the product for the set of words constituting the alarm of the probabilities that each respective word of the alarm is present in alarms belonging to each category multiplied by the probability of each category; and

comparing the results of the preceding step for both categories.

Thus the above steps use counts to compare the probability of a given alarm belonging to one or the other category with an optimum number of computation steps, consequently minimizing computation time.

Correction by the false alarm suppression module of the classification of new alarms during the validation stage advantageously includes the following steps:

correcting the category of a new alarm previously classified by said module if it receives a notification from the human operator indicating that said preceding classification of said new alarm is false;

decrementing the counts designating the cumulative numbers of occurrences of words in the category falsely classified;

incrementing the counts designating the cumulative numbers of occurrences of words in the corrected category.

Thus adjusting the counts is an effective and fast way to enhance the training of the false alarm suppression module.

The invention also consists in a false alarm suppression module comprising:

data processing means for automatically classifying alarms into two categories consisting of false and true alarms depending on particular criteria based on progressive training based on the expertise of a human operator responsible for initial manual classification of alarms; and

memory means used during an initial training stage of the progressive training process to store diagnoses by the human operator concerning a particular number of initial alarms making it possible, for a given initial alarm, to extract the set of words constituting said given initial alarm and associate each word of said set of words with a respective count designating the cumulative number of occurrences of said word in one or the other of the two categories; and

the data processing means further classifying new alarms as a function of the stored diagnoses under the supervision of the human operator, who confirms or corrects the classifications of new alarms.

During an operational stage, the data processing means advantageously classify new alarms autonomously if the rate at which the classifications of new alarms are corrected during the validation stage falls below a particular threshold.

The module preferably further includes a storage module for storing false alarms during the operational stage so that only true alarms are sent to an alarm presentation console.

The invention also consists in a monitored information system including an internal network to be monitored, intrusion detection sensors, an alarm management system, an alarm presentation console, and a false alarm suppression module having the above features.

### BRIEF DESCRIPTION OF THE DRAWINGS

Other features and advantages of the invention emerge on reading the following description given by way of non-limiting example and with reference to the appended drawings, in which:

FIG. 1 is a highly diagrammatic view of a monitored information system including a false alarm suppression module of the invention; and

FIG. 2 is a highly diagrammatic flowchart illustrating the steps of a method of the invention for suppressing false alarms produced in an information security system.

### DETAILED DESCRIPTION OF EMBODIMENTS

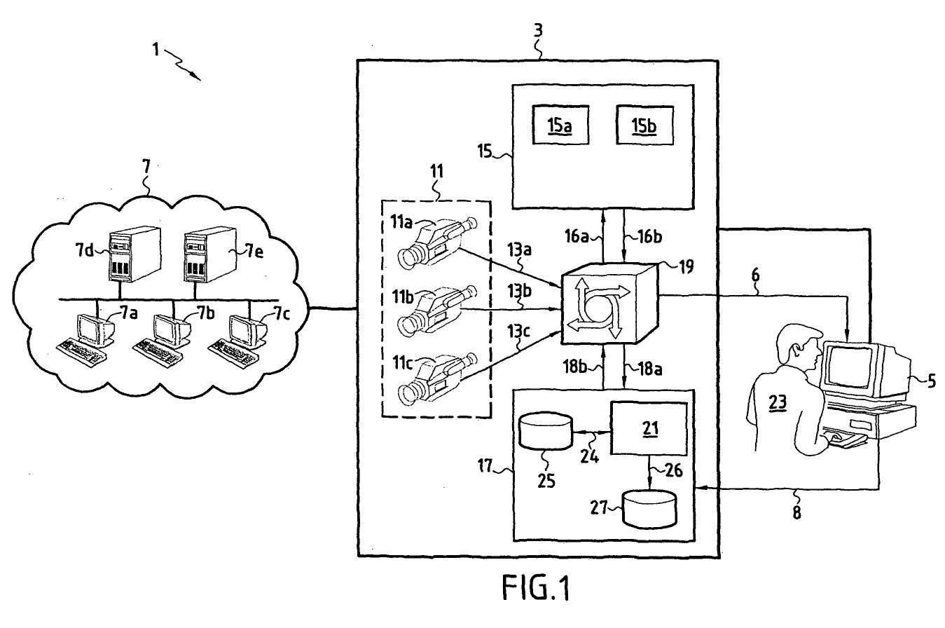

FIG. 1 shows highly diagrammatically an example of a monitored information network or system 1 comprising an information security system 3, an alarm presentation console 5, and an internal network 7 to be monitored comprising a set of entities, for example workstations 7a, 7b, 7c, servers 7d, web proxies 7e, etc.

The information security system 3 includes a set 11 of intrusion detection sensors 11a, 11b and 11c that send alarms when attacks are detected and an alarm management system 15 that analyzes alarms sent by the sensors 11a, 11b and 11c and comprises alarm processing modules 15a, 15b.

Furthermore, in accordance with the invention, the information security system 3 includes a false alarm suppression module 17 connected via a router 19 to the intrusion detection sensors 11a, 11b and 11c, to the alarm management system 15, and to the alarm presentation console 5.

The router 19 is connected to the false alarm suppression module 17 via connections 18a and 18b, to the intrusion detection sensors 11a, 11b and 11c via connections 13a, 13b and 13c, to the alarm management system 15 via connections 16a and 16b, and to the alarm presentation console 5 via a connection 6.

The false alarm suppression module 17 includes data processing means 21 for automatically classifying (i.e. marking) alarms into two categories, consisting of false alarms and true alarms, depending on particular criteria based on progressive training of the false alarm suppression module 17 based on the expertise of a human operator 23 responsible for initial manual classification of alarms. These particular criteria include comparing the probabilities of alarms belonging to one or the other of the two categories. Thus the processing means 21 of the false alarm suppression module 17 can execute a computer program designed to implement a false alarm suppression method of the present invention.

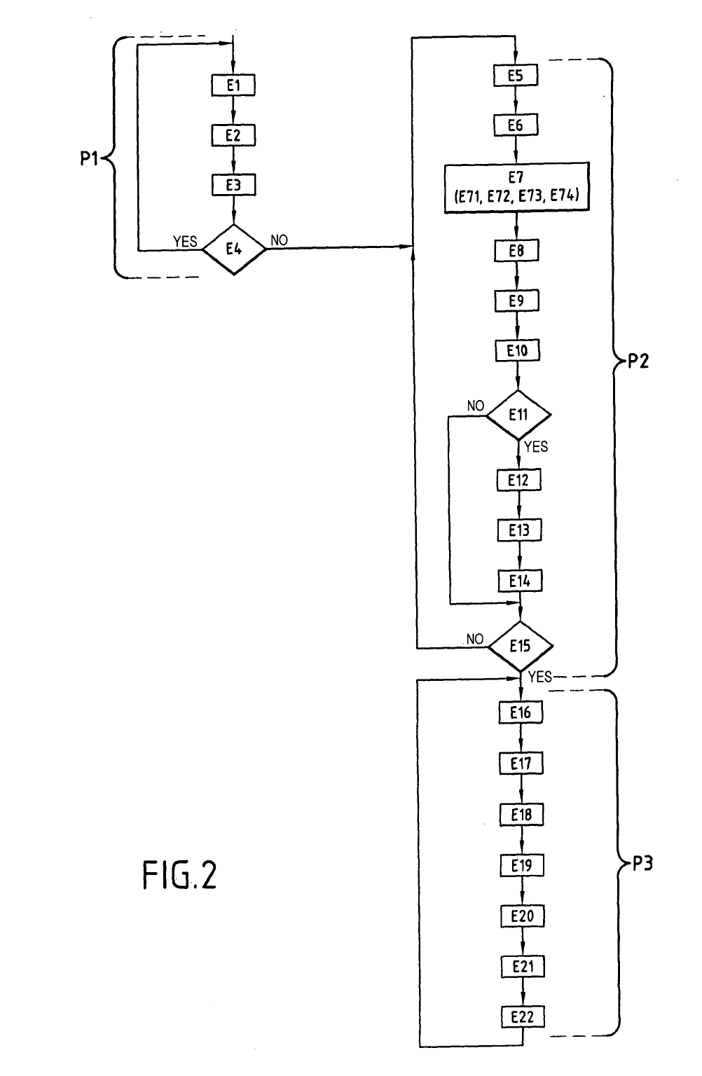

The false alarm suppression module 17 of the invention is adaptive, in the sense that it progressively integrates the expertise of the human operator 23 responsible for initial manual qualification of false alarms, and has three successive stages of operation (see also FIG. 2).

The first stage P1 is an initial training stage in which the false alarm suppression module 17 does not mark the alarms but merely stores the diagnoses of the human operator 23. The false alarm suppression module 17 includes memory means 25 enabling the processing means 21 to store the diagnoses of the human operator 23 relating to a particular number of initial alarms.

The second stage P2 is a validation stage in which the processing means 21 of the false alarm suppression module 17 proceed to classify new alarms as a function of the stored diagnoses under the supervision of the human operator 23, who confirms or corrects the classification of new alarms. When a sufficient number of alarms have passed through the false alarm suppression module 17, for example a number above a threshold fixed by the human operator 23, the false alarm suppression module 17 begins to mark alarms sent to it via the connection 18a.

During the validation stage, the false alarm suppression module 17 advantageously uses confirmation or correction of its classifications of new alarms by the human operator 23 to minimize a correction rate, thereby enabling it to increase the reliability of any subsequent classification of new alarms.

Thus the first or initial training stage and second or validation stage progressively train the false alarm suppression module 17.

The third stage P3 is an operational stage in which new alarms are classified autonomously by the processing means 21 of the false alarm suppression module 17 providing the rate at which the classifications of new alarms are corrected during the validation stage falls below a particular threshold. Accordingly, the false alarm suppression module 17 marks alarms and sends only true alarms to the alarm presentation console 5. False alarms are either suppressed directly or stored in the memory means 25 or preferably in ancillary storage means 27 via a connection 26. The choice between suppressing or storing false alarms may be made by the human operator 23.

Accordingly, the false alarm suppression module 17 processes alarms coming directly from the intrusion detection sensors 11a, 11b, 11c via the connections 13a, 13b, 13c, and 18a or possibly from the other alarm processing modules 15a, 15b via the connections 16b and 18a. Each alarm generated by an intrusion detection sensor 11a, 11b, 11c or an alarm processing module 15a, 15b is submitted to the false alarm suppression module 17 for analysis. The false alarm suppression module 17 marks alarms that it deems to be false alarms and submits them to the alarm management system 15 (connections 18b, 16a). The alarms and their markings are then sent to the alarm presentation console 5 (connections 16b, 6) to be consulted by the human security operator 23.

Note that the human operator 23 can still intervene during the second and third stages, for example via a direct connection 8 to the false alarm suppression module 17, to revise the its diagnoses. In the event of an erroneous qualification of an alarm by the false alarm suppression module 17, the human operator 23 can correct the diagnosis of the false alarm suppression module 17 a posteriori via the alarm presentation console 5. This correction is sent to the false alarm suppression module 17 (connection 8), which revises its subsequent diagnoses by taking account of the correction made by the human operator 23.

Thus the training of the false alarm suppression module 17 is supervised by the human security operator 23, who teaches it how to classify alarms. Moreover, this training is progressive in the sense that the false alarm suppression module 17 initially makes marking errors but its diagnoses become progressively more reliable as the human security operator 23 confirms or cancels its markings. Finally, when the filtering by the false alarm suppression module 17 is sufficiently reliable, i.e. when its classification error rate is tolerable, the alarms identified as being false alarms (false positives) can be either suppressed directly or stored in the ancillary storage means 27, so that only true alarms (true positives) are presented to the human operator 23. This facilitates the work of the human operator 23 because the volume of alarms sent to the operator is very small.

Thus the criterion for deciding whether an alarm is a true or a false positive is based on comparing the probabilities of the alarms belonging to one or the other of the two categories.

An alarm message a (or, more simply, an alarm a) may be defined as a set of n words m_{iε{1, . . . ,n}}, where n is an integer that can vary from one alarm to another:
a=(m₁, . . . ,mₙ).

The words of an alarm designate the nature of an attack on the information system 1, the identity of the victims, the presumed identity of the attackers, the type of weakness exploited, and the time of day, for example.

In accordance with the invention, given an alarm a, the problem Q to be solved is to determine whether the probability that the alarm a is a false positive is greater than the probability that the alarm a is a true positive. If so, then the alarm a is marked as a false positive and if not the alarm a is not changed (i.e. it is considered as a true positive).

P(vp|m₁, . . . ,mₙ) is the probability that an alarm a containing the words m₁, . . . , mₙ is a true positive vp and P(fp|m₁, . . . ,mₙ) is the probability that an alarm a containing the words m₁, . . . , mₙ is a false positive fp.

The problem Q is therefore to determine whether:
P(fp|m₁, . . . ,mₙ)≦P(vp|m₁, . . . , mₙ)

However, from the definitions of the conditional probabilities:

$$P ( fp \vert {m}_{1} , … , {m}_{n} ) = \frac{P ( fp , {m}_{1} , … , {m}_{n} )}{P ( {m}_{1} , … , {m}_{n} )} and$$

$$P ( vp \vert {m}_{1} , … , {m}_{n} ) = \frac{P ( vp , {m}_{1} , … , {m}_{n} )}{P ( {m}_{1} , … , {m}_{n} )} .$$

Consequently, the problem Q is reduced to determining whether:
P(fp,m₁, . . . ,mₙ)≦P(vp,m₁, . . . ,mₙ)

Furthermore, given that P(fp|m₁, . . . , mₙ)=P(m₁, . . . ,mₙ|fp).P(fp) and P(vp|m₁, . . . ,mₙ)=P(m₁, . . . ,mₙ|vp).P(vp), and assuming that the variables mᵢ are conditionally independent of each other, it follows that:
P(fp, m₁, . . . , mₙ)=P(m₁|fp) . . . P(mₙ|fp).P(fp) and
P(vp,m₁, . . . ,mₙ)=P(m₁|vp) . . . P(mₙ|vp).P(vp).

The values P(mᵢ|C) represent the probability that a word mᵢ is present in an alarm that belongs to the class or category Cε{vp,fp}.

During training of the false alarm suppression module 17, the processing means 21 construct counts H_{C} that indicate the frequencies of the various words in the two categories CΕ{vp,fp}. The false alarm suppression module 17 constructs a first hashing table H_{fp} that associates with each word mᵢ a value H_{fp}(mᵢ) that designates the cumulative number of occurrences of the word mᵢ in false positives and a second hashing table Hᵥₚ that associates with each word mᵢ a value Hᵥₚ(mᵢ) that designates the cumulative number of occurrences of the word mᵢ in true positives. Below, words(H_{C}) designates the definition domain of the hashing table H_{C}, i.e. the set of words corresponding to the category Cε{vp,fp}.

Consequently, the total number of occurrences of words in true positives is given by the following equation:

$${N}_{vp} = {\sum }_{{m}_{i} ∈ words ( {H}_{vp} )} {H}_{vp} ( {m}_{i} )$$

Similarly, the total number of occurrences of words in false positives is given by the following equation:

$${N}_{fp} = {\sum }_{{m}_{i} ∈ words ( {H}_{fp} )} {H}_{fp} ( {m}_{i} )$$

Moreover, the probability that a word mᵢ is present in an alarm that belongs to the class Cε{vp,fp} is given by the following equation:

$$P ( {m}_{i} \vert C ) = \frac{{H}_{C} ( {m}_{i} )}{{N}_{C}}$$

Also, the probability of a class C is given by the following equation:

$$P ( C ) = \frac{{N}_{C}}{{N}_{vp} + {N}_{fp}}$$

Consequently, the last two equations enable the probabilities P(fp,m₁, . . . ,mₙ) and P(vp,m₁, . . . ,mₙ) to be computed and thus enable the above problem Q to be solved.

FIG. 2 is a highly diagrammatic flowchart showing the steps of the method of suppressing false alarms produced in an information security system 3.

Steps E1 to E3 denote the storage in the memory means 25 of the false alarm suppression module 17 of diagnoses made by the human operator 23 during the initial training stage P1.

In step E1, the false alarm suppression module 17 receives a given initial alarm a′.

In step E2, the false alarm suppression module 17 proceeds to extract the set of words m′, constituting this given initial alarm: a′=(m′₁, . . . ,m′ₙ).

In step E3, the false alarm suppression module 17 associates each word m′ᵢ in the set of words {m′ᵢ, . . . ,m′ₙ} with counts H_{C}(m′ᵢ) denoting the cumulative number of occurrences of the word m′ᵢ in one or the other of the two categories Cε{vp,fp}.

Step E4 is a test for verifying whether the number of alarms that have passed through the false alarm suppression module 17 has reached a sufficient number. The process therefore loops to step E1 if the number of alarms is below a threshold number set by the human operator 23, for example.

Otherwise, if the number of alarms is not below the threshold number, the process proceeds to steps E5 to E14 of alarm classification by the false alarm suppression module 17 during the validation stage P2.

Note that no marking is effected by the false alarm suppression module 17 during the initial training stage P1.

Step E5 denotes the reception by the false alarm suppression module 17 of a given new alarm a.

In step E6, the false alarm suppression module 17 proceeds to extract the set of words mᵢ constituting this given new alarm a=(m₁, . . . ,mₙ).

In step E7, the probabilities of the given new alarm a belonging to one or the other of the categories are compared:
P(fp|m₁, . . . ,mₙ)≦P(vp|m₁, . . . ,mₙ).

This comparison may include the following substeps E71 to E74:

In step E71, the false alarm suppression module 17 computes for each word mᵢ of the set of words {m₁, . . . ,mₙ} of the new alarm a the probability that each word mᵢ is present in alarms belonging to one or the other of the categories C (Cε{vp,fp}) by determining the ratio between the count H_{C}(mᵢ) denoting the cumulative number of occurrences of each word mᵢ in the alarms of one or the other of the categories C and the total number N_{C} of occurrences of words in one or the other of the categories, respectively, that is to say:

$$P ( {m}_{i} \vert C ) = \frac{{H}_{C} ( {m}_{i} )}{{N}_{C}} .$$

In step E72, the false alarm suppression module 17 computes the probability of each category by determining the ratio between the total number N_{C} of occurrences of words in the alarms of each category C and the total number of words Nᵥₚ+N_{fp}, that is to say:

$$P ( C ) = \frac{{N}_{C}}{{N}_{vp} + {N}_{fp}} .$$

In step E73, the false alarm suppression module 17 computes the product, over the set of words {m₁, . . . ,mₙ} constituting the given new alarm a, of the probabilities P(mᵢ|C) that each respective word of that alarm is present in alarms belonging to each category multiplied by the probability of each category P(C), that is to say:

$$( {\prod }_{i} P ( {m}_{i} \vert C ) ) \cdot P ( C )$$

In step E74, the false alarm suppression module 17 compares the result of the preceding step for both categories, that is to say:

$$( {\prod }_{i} P ( {m}_{i} \vert fp ) ) \cdot P ( fp ) \leq ( {\prod }_{i} P ( {m}_{i} \vert vp ) ) \cdot P ( vp ) .$$

In step E8, the given new alarm a is classified by the false alarm suppression module 17 in one of the two categories depending on the result of the comparison in the preceding step E7.

In step E9, the false alarm suppression module 17 increments the counts H_{C}(mᵢ) depending on the category Cε{vp,fp} of the given new alarm.

Then, in step E10, the false alarm suppression module 17 sends the given new alarm a as classified (marked) in this way to the alarm presentation console 5.

Where appropriate, the human operator 23 interacts with the false alarm suppression module 17 via the alarm presentation console S to correct an erroneous diagnosis made by the false alarm suppression module 17.

In step E11, if the false alarm suppression module 17 receives a notification from the human operator 23 indicating that the preceding classification C of the new alarm a is false, then the false alarm suppression module 17 proceeds to correct the diagnosis through steps E12 to E14; otherwise, the process goes directly to step E15.

In step E12, the false alarm suppression module 17 corrects the category of the new alarm a to match the notification from the human operator 23. In other words, the false alarm suppression module 17 marks the new alarm a with a classification C̅ that is the opposite of the earlier classification C.

In step E13, the false alarm suppression module 17 decrements the counts H_{C}(mᵢ) designating the cumulative numbers of occurrences of words in the category C falsely classified.

In step E14, the false alarm suppression module 17 increments the counts H _{C̅}(mᵢ) designating the cumulative numbers of occurrences of words in the corrected category C̅.

Step E15 is a test for verifying whether the classification error rate is tolerable.

If the rate of correction of the classification of new alarms in the validation stage P2 is not below some particular threshold, the process loops to step E5.

Otherwise, there follow steps E16 to E22 of alarms being classified by the false alarm suppression module 17 during the operational stage P3. Steps E16 to E21 are similar to steps E5 to E10 of the validation stage P2.

On receiving another new alarm a in step E16, the false alarm suppression module 17 proceeds in step E17 to extract the set of words mᵢ that constitute the new alarm a=(m₁, . . . ,mₙ). Step E18 compares the probabilities of the new alarm belonging to one or the other of the categories. Step E19 classifies the new alarm. Step E20 increments the counts depending on the category in which the new alarm has been classified. In step E21, the false alarm suppression module 17 sends the classified new alarm to the alarm presentation console 5.

Finally, false alarms are stored in the storage means 27 in step E22. Alternatively, false alarms can be suppressed in step E22.

Thus the false alarm suppression module 17 of the invention evaluates the probability that an alarm is a false positive as a function of the words that constitute it. The false alarm suppression module 17 marks the alarms that it deems to be false positives and sends the alarms and their marking to the human security operator 23, who can modify an erroneous diagnosis made by the false alarm suppression module 17 via the alarm presentation console 5. When this happens, the false alarm suppression module 17 revises its subsequent diagnoses by taking the correction into account.

In this way, the reliability of the false alarm suppression module 17 in processing alarms increases as the human operator 23 corrects its diagnoses.

1. A method of suppressing false alarms produced in a monitored information system (1), wherein alarms are classified automatically by a false alarm suppression module (17) into two categories consisting of false and true alarms depending on particular criteria based on progressive training of said module (17) based on the expertise of a human operator (23) responsible for initial manual classification of alarms, said progressive training including the following stages:
an initial training stage (P1) in which said false alarm suppression module (17) proceeds to store diagnoses by the human operator (23) concerning a particular number of initial alarms and comprising, for a given initial alarm, extracting a set of words constituting said given initial alarm and associating each word of said set of words with a count designating the cumulative number of occurrences of said word in one of the two categories; and
a validation stage (P2) in which said false alarm suppression module (17) classifies new alarms as a function of the stored diagnoses under the supervision of the human operator (23), who confirms or corrects its classification of new alarms.

2. A The method according to claim 1, wherein said particular criteria include comparing the probabilities of alarms belonging to one or the other of said two categories.

3. The method according to claim 1, wherein in the validation stage (P2) the false alarm suppression module (17) uses said confirmation or correction of its classifications of new alarms by the human operator (23) to minimize a correction rate, thereby enabling it to increase the reliability of any subsequent classification of new alarms.

4. The method according to claim 3, wherein it includes an operational stage (P3) in which new alarms are classified autonomously if the correction rate of the classification of new alarms in the validation stage (P2) falls below a particular threshold.

5. The method according to claim 4, wherein in the operational stage (P3), false alarms are suppressed or stored in storage means (27) and only true alarms are sent to an alarm presentation console (5).

6. The method according to claim 1, wherein the classification of alarms during the validation stage (P2) and the operational stage (P3) includes the following steps for a given new alarm:
extracting the set of words constituting said given new alarm;
comparing the probabilities of the given new alarm belonging to one and the other of said categories;
classifying the given new alarm in one of the two categories depending on the result of the comparison in the preceding step;
incrementing the counts as a function of the category of the given new alarm; and
sending the given new alarm as classified in this way to the alarm presentation console (5).

7. The method according to claim 6, wherein comparing the probabilities of the given new alarm belonging to one or the other of said categories includes the following steps:
computing for each word of the set of words of said new alarm the probability that each word is present in alarms belonging to one or the other of the categories by determining the ratio between the count designating the cumulative number of occurrences of each word in alarms of one or the other of the categories and the total number of occurrences of words in one or the other of the categories, respectively;
computing the probability of each category by determining the ratio between the total number of occurrences of words in alarms of each category and the total number of words;
computing the product for the set of words constituting the alarm of the probabilities that each respective word of the alarm is present in alarms belonging to each category multiplied by the probability of each category; and
comparing the results of the preceding step for both categories.

8. The method according to claim 1, wherein correction by said false alarm suppression module (17) of the classification of new alarms during the validation stage (P2) includes the following steps:
correcting the category of a new alarm previously classified by said module (17) if it receives a notification from the human operator (23) indicating that said preceding classification of said new alarm is false;
decrementing the counts designating the cumulative numbers of occurrences of words in the category falsely classified;
incrementing the counts designating the cumulative numbers of occurrences of words in the corrected category.

9. A false alarm suppression module, wherein it comprises:
data processing means (21) for automatically classifying alarms into two categories consisting of false and true alarms depending on particular criteria based on progressive training based on the expertise of a human operator (23) responsible for initial manual classification of alarms; and
memory means (25) used during an initial training stage of the progressive training process to store diagnoses by the human operator (23) concerning a particular number of initial alarms making it possible, for a given initial alarm, to extract the set of words constituting said given initial alarm and associate each word of said set of words with a respective count designating the cumulative number of occurrences of said word in one or the other of the two categories;
the data processing means (21) further classifying new alarms as a function of the stored diagnoses under the supervision of the human operator (23), who confirms or corrects the classifications of new alarms.

10. The module according to claim 9, wherein during an operational stage (P3) the data processing means (21) classify new alarms autonomously if the rate at which the classifications of new alarms are corrected during the validation stage (P2) falls below a particular threshold.

11. The module according to claim 10, wherein it further includes a storage module (27) for storing false alarms during the operational stage so that only true alarms are sent to an alarm presentation console (5).

12. A monitored information system comprising an internal network (7) to be monitored, intrusion detection sensors (11a, 11b, 11c), an alarm management system (15), and an alarm presentation console (5), wherein the monitored information system further comprises a false alarm suppression module (17) according to claim 9.
